(19) United States
(12) Patent Application Publication
(10) Pub. No.: US 2010/0289315 A1
(43) Pub. Date: Nov. 18, 2010

(54) APPARATUS FOR PORTABLE CUSHIONS FOR HEAD AND NECK SUPPORT OF A PASSENGER IN A VEHICLE

(76) Inventor: Steve Jackson, Modesto, CA (US)

Correspondence Address: Steve Jackson, 1508 Rose Guarden Ct., Modesto, CA, 95356, US

(21) Appl. No.: 12/465,618

(22) Filed: May 13, 2009

(51) Int. Cl. B60N 2/48; A47C 7/38

(52) U.S. Cl. 297/397

(57) ABSTRACT

An apparatus for portable cushions for head and neck support of a passenger in a vehicle includes a rear rod for joining the apparatus to a seat headrest of the vehicle. Side rods are joined to the rear rod and extend out from the rear rod for extending beyond the seat headrest. Arms extend generally downward from ends of the side rods for positioning lengths of the arms on either side of the passenger's head and neck. Cushions are joined to the lengths to be positioned on either side of the passenger's head and neck for supporting the passenger's head and neck while the passenger is seated in the vehicle.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to vehicle safety equipment. More particularly, the invention relates to portable cushions for head and neck support for use by vehicle passengers.

### BACKGROUND OF THE INVENTION

The present invention relates to a portable headrest for vehicle use that offers additional head and neck support for children in the vehicle. Children often fall asleep while riding in vehicles, and when they fall asleep, they tend to lean over or slump to the side. This can be uncomfortable and may cause injury to the child. Also, when a child leans over in the seat, the seat belt is not located in the correct position across the child's chest. In some cases the seat belt may be across the face of the child. Furthermore, a child who sleeps in a vehicle may lean against the vehicle door, which may open accidentally without warning, and the child may fall out of the vehicle. It is therefore an objective of the present invention to provide additional head and neck support for a child riding in the rear seat of a vehicle to keep the child in an upright position.

In view of the foregoing, there is a need for improved techniques for providing a portable headrest with cushions for head and neck support.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagrammatic front view of a portable headrest for a vehicle, in accordance with an embodiment of the present invention.

Unless otherwise indicated illustrations in the figures are not necessarily drawn to scale.

### SUMMARY OF THE INVENTION

To achieve the forgoing and other objects and in accordance with the purpose of the invention, an apparatus for portable cushions for head and neck support of a passenger in a vehicle is presented.

In one embodiment, an apparatus for portable cushions for head and neck support of a passenger in a vehicle. The apparatus includes means for joining the apparatus to a seat headrest of the vehicle, means joined to the joining means for extending beyond the seat headrest, means extending generally downward from the extending means for positioning lengths on either side of the passenger's head and neck and means joined to the lengths for supporting the passenger's head and neck while the passenger is seated in the vehicle. Various other embodiment further include means for retaining a shoulder portion of a seatbelt in a comfortable position and means for attachment to a latch located in a rear of the vehicle.

In another embodiment, an apparatus for portable cushions for head and neck support of a passenger in a vehicle is presented. The apparatus includes a rear rod for joining the apparatus to a seat headrest of the vehicle. Side rods are joined to the rear rod and extend out from the rear rod for extending beyond the seat headrest. Arms extend generally downward from ends of the side rods for positioning lengths of the arms on either side of the passenger's head and neck. Cushions are joined to the lengths to be positioned on either side of the passenger's head and neck for supporting the passenger's head and neck while the passenger is seated in the vehicle. Another embodiment further includes seatbelt slots for retaining a shoulder portion of a seatbelt in a comfortable position. Various other embodiments further include means for adjusting a width of the rear rod, means for adjusting a position along the side rods to which the rear rod is joined and means for adjusting each of the arms to effect a width between the arms, means for adjusting a position of joining of the cushions to the lengths. Still other embodiment further include a safety belt for attachment to a latch located in a rear of the vehicle and clips for joining the rear rod to a rear of metal inserts of the seat headrest.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

The present invention will now be described in detail with reference to embodiments thereof as illustrated in the accompanying drawings.

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Preferred embodiments of the present invention provide a portable headrest for vehicle use. In preferred embodiments the headrest is placed in the back seat of a vehicle up and over a rear headrest of the vehicle. Preferred embodiments provide additional head and neck support for children sleeping in the vehicle.

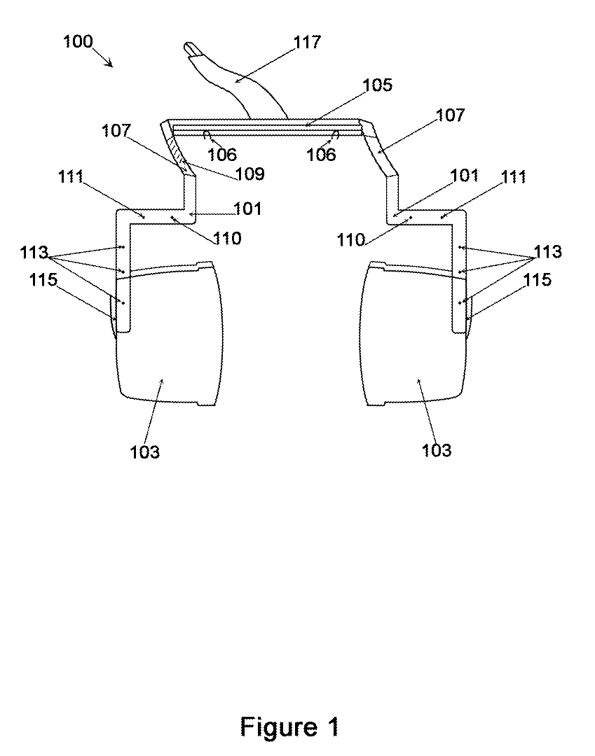

FIG. 1 is a diagrammatic front view of a portable headrest 100 for a vehicle, in accordance with an embodiment of the present invention. In the present embodiment, headrest 100 comprises arms 101, cushions 103 and a telescoping rear rod 105. Rear rod 105 is places on the rear portion of a vehicle headrest in the back seat. Headrest 100 is equipped with clamps 106 that clamp onto the rear of metal inserts of the vehicle headrest, which are inserted into the vehicle's back seat. Alternate embodiments may be implemented for use in vehicles where the rear headrests do not have metal inserts. For example, without limitation, one alternate embodiment may comprise an elastic band that wraps around the rear vehicle headrest, and another alternate embodiment may comprise adjustable arms that may be tightened onto the rear vehicle headrest to hold the portable headrest in place. In the present embodiment, headrest 100 can be adjusted in width for accommodation in most vehicles. The width of clamps 106 may be adjusted by shortening or lengthening telescoping rear rod 105. In alternate embodiments, different means may be used to enable the headrest to fit on vehicle headrests of varying size for example, without limitation, the clamps may be mounted on a track on which the clamps may slide. In the present embodiment, the approximate length of rear rod 105 in its original position is eight inches; however, alternate embodiments may comprise rear rods that are longer or shorter depending on the type of vehicle in which the portable headrest is to be used. In the present embodiment, headrest 100 can also be adjusted in depth to mount on rear vehicle headrests of varying size by enabling rear rod 105 to slide back and forth along side rods 107. Side rods 107 comprise grooves 109 in which rear rod 105 stops. In alternate embodiments various different means may be used to stop the rear rod along the side rods such as, but not limited to, clamps, pins, screws, etc. In the present embodiment, side rods 107 are approximately three inches long; however, the side rods in alternate embodiments may be longer or shorter. In the present embodiment, arms 101 can also be made wider to accommodate a user's size and to maximize comfort when in use by telescoping in and out at horizontal sections 110. Once in the desired position, horizontal sections 110 are held in place by pins in holes 111. However, the horizontal sections in alternate embodiments may be held in place using different means such as, but not limited to, screws, clamps, grooves, etc.

Cushions 103 can also be adjusted up or down to maximize comfort by sliding up and down on arms 101 and are held in place by pins in pin holes 113. In alternate embodiments the cushions may be held in place with various different means including, but not limited to, clamps, screws, grooves, etc. Cushions 103 may also be rotated around arms 101 in an inward or outward direction according to the preference of the user. In alternate embodiments, the cushions may not rotate around the arms. In the present embodiment, cushions 103 are approximately twelve to fourteen inches in length to maximize head and neck support. However, cushions in alternate embodiments may be various different sizes to accommodate users and vehicles of various sizes. Adjustable seat belt slots 115 enable vehicle seatbelts to be used in a comfortable position along with headrest 100 while cushions 103 remain in place in their desired positions. Adjustable seat belt slots would be located on rear of arms. Seat belt slots 115 may slide up or down to provide maximum comfort. Seat belt slots 115 enable a child to rest and sleep more comfortably without the seat belt coming across the child's face or other improper location such as, but not limited to, across the child's neck. A safety belt 117 is provided for additional safety to hold headrest 100 in place. Safety belt 117 attaches to a latch located in the rear of the vehicle. Alternate embodiments may be implemented without a safety belt.

In typical use of the present embodiment, headrest 100 generally prevents a child from leaning over while sleeping in a vehicle by supporting the child's head and neck with cushions 103. Headrest 100 also provides additional safety to a child who sleeps in the vehicle by generally preventing the child from leaning up against the vehicle rear door, which may open accidentally without warning. This reduces the risk of the child falling out of the vehicle. Also, by keeping a child in an upright position, the use of headrest 100 enables the seat belt in the vehicle to be utilized to its full purpose.

Alternate embodiments may be implemented that comprise fewer adjustment points or no adjustment points. For example, without limitation, one alternate embodiment may comprise a frame that is made to fit a specific type of vehicle so that the clamping device and rear rod do not need to be adjusted. In this embodiment the only adjustment points would be at the arms and cushions to maximize comfort for the user. Other alternate embodiments may be made for specific types of vehicles and for users of a particular size so that no adjustment points are required.

Another alternate embodiment may be implemented for adult use. This embodiment may comprise larger cushions and shorter arms to accommodate the larger size of most adults.

Alternate embodiments of the present invention may also comprise various different features such as, but not limited to, the following. Some alternate embodiments may comprise an attachment latch on the outside portion of the headrest near each cushion that enable two additional cushions to be attached, one on each side. In other alternate embodiments, the cushions may be equipped with a with side pockets and/or small radio and/or or speakers that attach to a portable audio device. Other alternate embodiments may comprise decorative cushions varying in size, shapes or color or detachable cushions. Yet other alternate embodiments may comprise a folding mechanism or mechanisms that enable the portable headrest to be folded for easy storage. Those skilled in the art, in light of the present teachings, will readily recognize that a multiplicity of additional features may be available on alternate embodiments of the present invention such as, but not limited to, cushion covers, trays, sun visors, etc.

Having fully described at least one embodiment of the present invention, other equivalent or alternative methods of providing a portable headrest according to the present invention will be apparent to those skilled in the art. The invention has been described above by way of illustration, and the specific embodiments disclosed are not intended to limit the invention to the particular forms disclosed. For example, the particular implementation of the headrest may vary depending upon the particular location in which the headrest is to be used. The headrests described in the foregoing were directed to rear seat, automobile implementations; however, similar techniques are to implement portable headrests for use in the front seat of an automobile or for different types of vehicles such as, but not limited to, airplanes, buses, etc. Implementations of the present invention for use in various locations are contemplated as within the scope of the present invention. The invention is thus to cover all modifications, equivalents, and alternatives falling within the spirit and scope of the following claims.

Claim elements and steps herein have been numbered and/or lettered solely as an aid in readability and understanding. As such, the numbering and lettering in itself is not intended to and should not be taken to indicate the ordering of elements and/or steps in the claims.

What is claimed is:

1. An apparatus for portable cushions for head and neck support of a passenger in a vehicle, the apparatus comprising:
means for joining the apparatus to a seat headrest of the vehicle;
means joined to said joining means for extending beyond the seat headrest;
means extending generally downward from said extending means for positioning lengths on either side of the passenger's head and neck; and
means joined to said lengths for supporting the passenger's head and neck while the passenger is seated in the vehicle.

2. The apparatus as recited in claim 1, further comprising means for retaining a shoulder portion of a seatbelt in a comfortable position.

3. The apparatus as recited in claim 1, further comprising means for attachment to a latch located in a rear of the vehicle.

4. An apparatus for portable cushions for head and neck support of a passenger in a vehicle, the apparatus comprising:
a rear rod for joining the apparatus to a seat headrest of the vehicle;
side rods joined to said rear rod and extending out from said rear rod for extending beyond the seat headrest;
arms extending generally downward from ends of said side rods for positioning lengths of said arms on either side of the passenger's head and neck; and
cushions joined to said lengths to be positioned on either side of the passenger's head and neck for supporting the passenger's head and neck while the passenger is seated in the vehicle.

5. The apparatus as recited in claim 4, further comprising seatbelt slots for retaining a shoulder portion of a seatbelt in a comfortable position.

6. The apparatus as recited in claim 4, further comprising means for adjusting a width of said rear rod.

7. The apparatus as recited in claim 4, further comprising means for adjusting a position along said side rods to which said rear rod is joined.

8. The apparatus as recited in claim 4, further comprising means for adjusting each of said arms to effect a width between said arms.

9. The apparatus as recited in claim 4, further comprising means for adjusting a position of joining of said cushions to said lengths.

10. The apparatus as recited in claim 4, further comprising a safety belt for attachment to a latch located in a rear of the vehicle.

11. The apparatus as recited in claim 4, further comprising clips for joining said rear rod to a rear of metal inserts of the seat headrest.
